(19) United States
(12) Patent Application Publication
(10) Pub. No.: US 2005/0103457 A1
(43) Pub. Date: May 19, 2005

(54) Production of sheet articles having self-cleaning surfaces by using a calendering process, sheet articles themselves and the use thereof

(75) Inventors: Edwin Nun, Billerbeck (DE); Markus Oles, Hattingen (DE)

Correspondence Address: OBLON, SPIVAK, MCCLELLAND, MAIER & NEUSTADT, P.C., 1940 DUKE STREET, ALEXANDRIA, VA, 22314, US

(73) Assignee: Degussa Ag, Duesseldorf (DE)

(21) Appl. No.: 10/506,238

(22) PCT Filed: Feb. 3, 2003
(86) PCT No.: PCT/EP03/01027

(30) Foreign Application Priority Data
Mar. 12, 2002 (DE) 10210667.3

(51) Int. Cl. B32B 5/16; D21H 19/66; B29C 70/64; B29C 59/02; B29C 43/22

(52) U.S. Cl. 162/135; 428/331; 428/327; 428/143; 162/205

(57) ABSTRACT

The invention relates to calendered web products with surfaces which have self-cleaning properties, and also to a simple process for producing these self-cleaning surfaces. The process of the invention is very simple, since it can utilize existing equipment. Calenders are usually used to produce web products from high-melt-viscosity polymers or web products with a fabric core. The process of the invention utilizes these calenders by applying microparticles on at least one roll of the calender. During passage of the webs, the microparticles are transferred to these via impression of the particles into the surface of the web products. The process of the invention provides access to self-cleaning surfaces which have particles with a fissured structure, without any need to apply an additional embossed layer or carrier layer of foreign material to the web products. Examples of uses of web products of the invention are truck tarpaulins, protective tarpaulins, awnings, sunshade roofs, and tenting.

The invention relates to calendered web products with self-cleaning surfaces, to a process for their production, and also to the use of these web products.

Various processes for treating surfaces to give these surfaces dirt- and water-repellent properties are known from surface technology. For example, it is known that if a surface is to have good self-cleaning properties it has to have a certain roughness, as well as hydrophobic properties. A suitable combination of structure and hydrophobic properties permits even small amounts of water set in motion on the surface to entrain adherent dirt particles and clean the surface (WO 96/04123, U.S. Pat. No. 3,354,022, C. Neinhuis, W. Barthlott, Annals of Botany 79, (1997), 667).

As early as 1982, A. A. Abramson in Chimia i Shisn russ. 11, 38 described the run-off of water droplets on hydrophobic surfaces, even at very small angles of inclination, especially if the surfaces have structuring, but without self-cleaning being acknowledged.

The prior art of EP 0 933 388 in relation to self-cleaning surfaces requires an aspect ratio >1 and a surface energy of less than 20 mN/m for self-cleaning surfaces, the aspect ratio being defined here as the quotient which is the ratio between the average height of the structure and its average width. The abovementioned criteria are to be found in the natural world, for example in lotus leaves. The plant has a surface formed from a hydrophobic waxy material and having elevations separated from one another by up to a few μm. Water droplets substantially come into contact only with these peaks. There are many descriptions in the literature of water-repellent surfaces of this type. A relevant example here is an article in Langmuir 2000, 16, 5754, by Masashi Miwa et al., describing the increase in contact angle and roll-off angle with increasing structuring of artificial surfaces formed from boehmite, applied to a spin-coated layer and then calcined.

Swiss Patent 268258 describes a process which generates structured surfaces by applying powders, such as kaolin, talc, clay, or silica gel. Oils and resins based on organosilicon compounds are used to secure the powders to the surface.

It is known that hydrophobic materials, such as perfluorinated polymers, can be used to produce hydrophobic surfaces. DE 197 15 906 A1 states that perfluorinated polymers, such as polytetrafluoroethylene or copolymers of polytetrafluoroethylene with perfluoroalkyl vinyl ethers, can generate hydrophobic surfaces which have structuring and have low adhesion to snow and ice. JP 11171592 describes a water-repellent product and its production, the dirt-repellent surface being produced by applying, to the surface to be treated, a film which comprises fine particles of metal oxide and comprises the hydrolyzate of a metal alkoxide or of a metal chelate. To consolidate this film, the substrate to which the film has been applied has to be sintered at temperatures above 400° C. This process is therefore usable only for substrates which can be heated to temperatures above 400° C.

The processes usually used hitherto for producing self-cleaning surfaces are complicated and in many cases have only restricted use. For example, embossing techniques are inflexible in relation to the application of structures to variously shaped three-dimensional bodies or sheets with or without fabric inserts. There is currently no suitable technology for producing flat, large-surface-area web product, particularly for web product with a fabric insert. Processes in which structure-forming particles are applied to surfaces by means of a carrier—for example an adhesive—have the disadvantage that the resultant surfaces are composed of various combinations of materials which, for example, have different coefficients of expansion when exposed to heat, and this can lead to damage to the surface. Severe flexing or creasing can lead to cracking in these surfaces made from various combinations of material, and for this reason products produced in this way are not very suitable as protective films or tarpaulins, since these should at least to some extent adapt to the contours of the articles to be provided with protective cover.

It was therefore an object of the present invention to provide a process for producing self-cleaning surfaces on web products with or without fabric insert, where the resultant web products can be flexed or creased with maximum freedom from cracking. A method of maximum simplicity should be used for the production process, and the self-cleaning surfaces should be durable.

Surprisingly, it has been found that applying nanostructured particles to a calender roll which serves for the smoothing of calendered web products can bond the particles securely on the surface of the calendered web products. The self-cleaning properties are achieved by virtue of the hydrophobic properties of the surfaces provided with the particles. At the same time, if the particles used are hydrophobic they can act as release agents. This is advantageous particularly when rubber-like compositions are being calendered.

The present invention provides calendered web products with at least one surface which has self-cleaning properties, wherein the surface has a securely anchored layer of microparticles which form elevations.

The present invention also provides a process for producing calendered web products of the invention with at least one surface which has self-cleaning properties and has elevations formed by microparticles, wherein at least one roller is used to impress microparticles into the surface of a calendered web product, where this surface has not yet solidified.

The present invention also provides films and coated fabrics, nonwovens, or felts with a surface which has self-cleaning properties and has surface structures with elevations, the production process being the process of the invention.

The process of the invention has the advantage that it can utilize existing equipment for producing calendered web products. Rolls are usually used to produce and smooth calendered web products. The process of the invention utilizes these rolls by applying microparticles to these rolls, preferably to the final calender roll or to the first roll downstream of the final calender roll. As the roll rotates, the microparticles are transferred from the roll to the web product via impression into the surface of the web, where this surface has not yet solidified. This simple method gives access to calendered web products with self-cleaning surfaces which have particles with a fissured structure, without any need to apply an additional emboss layer or a carrier layer of foreign material to the web product.

If the particles are hydrophobic particles, these simultaneously have the function of a release agent, since the powder applied to the roll prevents adhesion between the material of the calendered web products and the roll used for smoothing, especially if the compositions are rubber-like.

The calendered web products of the invention have the advantage that structure-forming particles are not secured by a carrier material, thereby avoiding an unnecessarily high number of combinations of material and the adverse properties associated therewith. Since the number of combinations of material is small, impairment of the flexibility of films of the invention is less marked than when a carrier layer is applied, and therefore there is also no substantial discernible loss of the product properties resulting therefrom.

The process of the invention gives access to self-cleaning calendered web products with or without (fabric) insert. The self-cleaning property in these products is brought about neither by application of additional material, other than application of particles, nor by any additional chemical process.

The fact that any desired size of surface can be provided with self-cleaning properties on one or both sides is proving to be very particularly advantageous.

The invention is described below by way of example, but is not restricted to these embodiments.

In the calendered web products of the invention with at least one surface which has self-cleaning properties, at least some regions of the surface have a securely anchored layer of microparticles which form elevations. The elevations present on at least some of the surface of the moldings and the hydrophobic properties of the surface ensure that these regions of the surface have only low wettability, and therefore have self-cleaning properties. In the method of obtaining the securely anchored layer of microparticles, microparticles, e.g. in the form of a non-coherent coating, are applied to a roll, and then this roll is used to impress and anchor the microparticles into the surface of the calendered web product, where this surface has not yet solidified. Particularly stable anchoring is obtained if use is made of microparticles which have a fine structure on the surface, since the fine structure can be filled to some extent by the calendering composition which has not yet solidified, and once the calendering composition has solidified/hardened a large number of anchoring points is present. For the purposes of the present invention, a layer of microparticles is a collection of microparticles forming elevations on the surface. The design of the layer may be such that the surface exclusively has microparticles, or almost exclusively has microparticles, or else has microparticles whose separation from one another is from 0 to 10 particle diameters, in particular from 0 to 3 particle diameters.

The calendered web products with surfaces with self-cleaning properties preferably have elevations with an average height of from 20 nm to 25 μm and with an average separation of 20 nm to 25 μm, preferably with an average height of from 50 nm to 10 μm and/or with an average separation of from 50 nm to 10 μm, and very particularly preferably with an average height of from 50 nm to 4 μm and/or with an average separation of from 50 nm to 4 μm. The calendered web products of the invention very particularly preferably have surfaces with elevations with an average height of from 0.25 to 1 μm and with an average separation of from 0.25 to 1 μm. For the purposes of the present invention, the average separation of the elevations is the separation between the highest elevation of an elevation and the next highest elevation. If an elevation has the shape of a cone, the tip of the cone is the highest elevation of the elevation. If the elevation is a rectangular parallelepiped, the uppermost surface of the rectangular parallelepiped is the highest elevation of the elevation.

The wetting of solids may be described by using the contact angle made by a water droplet with the surface. A contact angle of 0 degree here implies complete wetting of the surface. The contact angle is generally measured using devices which determine the contact angle optically. The static contact angles measured on smooth hydrophobic surfaces are usually smaller than 125°. The present solids with self-cleaning surfaces have static contact angles preferably greater than 130°, with preference greater than 140°, and very particularly preferably greater than 145°. It has been found, furthermore, that a surface has good self-cleaning properties only when it exhibits a difference of not more than 10° between advancing and receding angle, and for this reason surfaces of the invention preferably have a difference less than 10°, with preference less than 5°, and very particularly preferably less than 4°, between advancing and receding angle. To determine the advancing angle, a water droplet is placed on the surface by means of a cannula and the droplet is enlarged on the surface by adding water through the cannula. During enlargement, the margin of the droplet glides over the surface, and the contact angle is determined as the advancing angle. The receding angle is measured on the same droplet, but water is removed from the droplet through the cannula, and the contact angle is measured during reduction of the size of the droplet. The difference between the two angles is termed hysteresis. The smaller the difference, the smaller the interaction of the water droplet with the surface of the substrate, and therefore the better the lotus effect.

The aspect ratio for the elevations of the surfaces of the invention with self-cleaning properties is preferably greater than 0.15. The elevations formed by the particles themselves preferably have an aspect ratio of 0.3 to 0.9, particularly preferably from 0.5 to 0.8. The aspect ratio is defined here as the quotient which is the ratio of the maximum height to the maximum width of the structure of the elevations.

In the calendered web products of the invention with surfaces which have self-cleaning properties and have surface structures with elevations, the surfaces are preferably synthetic polymer surfaces into which the particles have been directly anchored and have not been bonded via carrier systems or the like.

The method of bonding the particles to the surface or anchoring the particles into the surfaces uses calender rolls to impress the particles into the calendered web products. To achieve the specified aspect ratios it is advantageous for at least some of the particles, preferably more than 50%, particularly preferably more than 75% of the particles, to be impressed into the surface of the web product only to the extent of 90% of their diameter. The surface therefore preferably has particles which have been anchored with from 10 to 90%, preferably from 20 to 50%, and very particularly preferably from 30 to 40%, of their average particle diameter within the surface, and which therefore have parts of their inherently fissured surface still protruding from the calendered web products. This method ensures that the elevations formed by the particles themselves have a sufficiently large aspect ratio, preferably at least 0.15. This method also ensures that the securely bonded particles have been bonded very durably to the surface of the web product. The aspect ratio is defined here as the ratio of maximum height to maximum width of the elevations. A particle assumed to be ideally spherical and protruding to the extent of 70% from the surface of the sheet extrudate has an aspect ratio of 0.7 according to this definition.

The microparticles securely bonded to the surface and forming elevations on the surface of the calendered web products have preferably been selected from silicates, minerals, metal oxides, metal powders, silicas, pigments, and polymers, very particularly preferably from fumed silicas, precipitated silicas, aluminum oxide, mixed oxides, doped silicates, titanium dioxides, and pulverulent polymers.

Preferred microparticles have a diameter of from 0.02 to 100 μm, particularly preferably from 0.1 to 50 μm, and very particularly preferably from 0.1 to 30 μm. However, suitable microparticles may also have a diameter smaller than 500 nm, or be composed of primary particles accreted to give agglomerates or aggregates of dimensions from 0.2 to 100 μm.

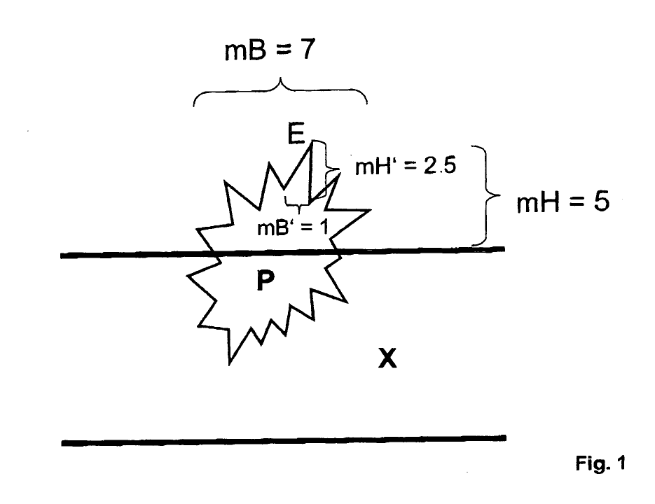

Particularly preferred microparticles which form the elevations of the structured surface of the web products are those whose surface has an irregular fine structure in the nanometer range. These microparticles with the irregular fine structure preferably have fine structures with an aspect ratio greater than 1, particularly preferably greater than 1.5. The aspect ratio is in turn defined as the quotient which is the ratio of the maximum height to the maximum width of the elevation. FIG. 1 illustrates diagrammatically the difference between the elevations formed by the particles and the elevations formed by the fine structure. The figure shows the surface of a calendered web product X which comprises particles P (only one particle being depicted to simplify the presentation). The elevation formed by the particle itself has an aspect ratio of about 0.71, calculated as the quotient which is the ratio between the maximum height of the particle mH, which is 5, since only that portion of the particle which protrudes from the surface of the calendered web product X contributes to the elevation, and the maximum width mB, which in turn is 7. A selected elevation of the elevations E present on the particles by virtue of their fine structure has an aspect ratio of 2.5, calculated as the quotient which is the ratio of the maximum height of the elevation mH′, which is 2.5, to the maximum width mB′, which in turn is 1.

Preferred microparticles whose surface has an irregular fine structure in the nanometer range are particles which comprise at least one compound selected from fumed silica, precipitated silicas, aluminum oxide, mixed oxides, doped silicates, titanium dioxides, and pulverulent polymers.

It can be advantageous for the microparticles to have hydrophobic properties, and the hydrophobic properties may be attributable to the properties of the materials themselves present on the surfaces of the particles, or else may be obtained through treatment of the particles with a suitable compound. The microparticles may have been provided with hydrophobic properties prior to or after application to the surface of the calendered web products. The particles may be hydrophobicized prior to or after application to the surface by treatment with a compound suitable for hydrophobicization, e.g. selected from the group of the alkylsilanes, the fluoroalkylsilanes, and the disilazanes.

Particularly preferred microparticles are described in more detail below. The particles may come from various fields. For example, they may be silicates, doped silicates, minerals, metal oxides, aluminum oxides, silicas, or titanium dioxides, Aerosils, or pulverulent polymers, e.g. spray-dried and agglomerated emulsions or cryogenically milled PTFE. Particularly suitable particle systems are hydrophobicized fumed silicas, known as Aerosils®. To generate the self-cleaning surfaces, hydrophobic properties are needed alongside the structure. The particles used may themselves be hydrophobic, for example pulverulent polytetrafluoroethylene (PTFE). The particles may have been provided with hydrophobic properties, for example Aerosil VPR 411® or Aerosil R 8200®. However, they may also be hydrophobicized subsequently. It is unimportant here whether the particles are hydrophobicized prior to application or after application. Examples of these particles to be hydrophobicized are Aeroperl 90/30®, Sipernat silica 350®, aluminum oxide C®, zirconium silicate, and vanadium-doped or VP Aeroperl P 25/20®. In the case of the latter, the hydrophobicization advantageously takes place by treatment with perfluoroalkylsilane compounds followed by heat-conditioning.

The calendered web products may have the elevations on both surfaces or only one surface, or only in some areas of one or both surfaces. The moldings of the invention preferably have the elevations on only one of the two surfaces.

The calendered web products themselves comprise at least one material suitable for calendering. The web product may comprise an insert. It can be advantageous for the calendered web products to comprise a felt, nonwoven, or fabric coated with a material suitable for calendering, and this coating may be present on one or both sides. If the coating is present only on one side, it is only this side which has microparticles as elevations. The material suitable for calendering and present in the calendered web product of the invention is very particularly preferably a compound selected from polyvinyl chloride (PVC), polyisobutylene, acrylonitrile-butadiene-styrene terpolymer (ABS), vulcanized rubber, and natural or synthetic rubber, and these compounds or substances may comprise the conventionally used auxiliaries, pigments, or additives. The nonwoven, felt, or fabric used as insert may comprise glass fibers, steel wires, polyester fibers, or natural fibers, for example.

The calendered web products of the invention are preferably produced by the process of the invention for producing calendered web products with at least one surface which has self-cleaning properties and has elevations formed by microparticles, which comprises at least one roller being used to impress microparticles into the surface of a calendered web product, where this surface has not yet solidified. The roll may be a roll specifically provided. However, it is particularly preferable for the microparticles to be impressed into the surface of the calendered web product by a roll needed for the production of conventional calendered web products, i.e. a roll which in any event is usually present. The process is preferably carried out by a method wherein microparticles are applied to one or more rolls, preferably the penultimate or final calender roll or the first roll downstream of the final calender roll, and during rotation of the roll are transferred from the roll to the web product by impression of the particles into the surface of the web, where this surface has not yet solidified. Calendering in itself is well known per se. Examples of information relating to calendering and relating to materials which can be used for calendering can be found in Kunststoff Handbuch 1, Die Kunststoffe Chemie, Physik, Technologie [Plastics Handbook 1, Plastics Chemistry, Physics, Technology] Bodo Carlowitz (editor), Hanser Verlag Munich, 1990, or in other technical books, or else in the references cited therein. The process of the invention for producing calendered web products encompasses not only calendering itself per se but also doubling, friction-calendering, and the single- or twin-sided coating of inserts.

The preferred method of impression is that some of the particles, preferably at least 50%, particularly preferably at least 75%, of the particles are impressed into the surface of the sheet extrudate only to the extent of not more than 90% of their diameter, preferably with from 10 to 90%, with preference with from 20 to 50%, and very particularly preferably with from 30 to 40%, of their average diameter.

The process of the invention may be used to produce calendered web products of the invention, and use may be made of any materials which can be calendered. During the calendering use may also be made of inserts which are coated on one or both sides during the calendering process with a material suitable for calendering. It can be advantageous for the calendered web products to comprise a felt, nonwoven, or fabric coated with a material suitable for calendering, and this coating may be present on one or both sides. If the coating is present only on one side, microparticles are also applied as elevations only to this side. The material suitable for calendering and present in the calendered web product of the invention is very particularly preferably a compound selected from polyvinyl chloride (PVC), polyisobutylene, acrylonitrile-butadiene-styrene terpolymer (ABS), vulcanized rubber, and natural or synthetic rubber, and these compounds or substances may comprise the conventionally used auxiliaries, pigments, or additives. The nonwoven, felt, or fabric used as insert may comprise glass fibers, steel wires, polyester fibers, or natural fibers, for example.

The process of the invention may be carried out using conventional calenders with the proviso that at least one apparatus is present for applying microparticles to the web product or to the roll or rolls. Examples of conventional calenders are 2-, 3-, 4- or 5-roll calenders, and the arrangement of the calender rolls may be a very wide variety of known layouts. A detailed description of the arrangement of calender rolls may in turn be found in Kunststoff Handbuch 1, Die Kunststoffe Chemie, Physik, Technologie [Plastics Handbook 1, Plastics Chemistry, Physics, Technology], Bodo Carlowitz (editor), Hanser Verlag Munich, 1990.

The microparticles which, in the process of the invention, are impressed by means of a roll into the surface of the calendered web product, where this surface has not yet solidified, may be applied, prior to impression, either to the surface of the web product or else to the surface of the roll used for impression. If the microparticles are applied to the web product, they may be applied by spraying, scattering, or similar methods. The microparticles are usually applied in loose form to the web product. It can also be advantageous for the microparticles to be applied to the roll prior to impression. They may be applied by spraying or scattering. Application of the microparticles to the roll can in particular be advantageous because the micropowder used on the roll, in particular the roll used for smoothing, prevents the material of the web product adhering to the roll during smoothing (and during impression of the microparticles), since there is usually no contact at all between the material and the roll, because the microparticles are applied very densely to the roll in order to achieve the preferred separations of the elevations. This release effect is naturally also achieved if the microparticles are applied to the web product. It can be advantageous for the microparticles to be applied both to the web product and to the roll.

An example of a method for spraying the microparticles onto the roll is spraying of microparticle powders or dispersions which comprise, besides the microparticles, a solvent which is preferably readily volatile, e.g. alcohols, in particular methanol, ethanol, or isopropanol. It can be advantageous for the dispersion to comprise from 0.1 to 20% by weight, preferably from 0.5 to 10% by weight, and particularly preferably from 0.75 to 5% by weight, of microparticles, based on the total weight of the dispersion.

It can be advantageous to use at least two rolls, and to impress microparticles into the surface of the calendered web products on two sides of the calendered web products. It can be particularly advantageous for the microparticles to be impressed by two opposite rolls between which the web product passes.

The microparticles used in the process of the invention are preferably those comprising at least one material selected from silicates, minerals, metal oxides, metal powders, silicas, pigments, and polymers. It is preferable to use microparticles which have a diameter of from 0.02 to 100 μm, particularly preferably from 0.1 to 50 μm, and very particularly preferably from 0.1 to 30 μm. However, suitable microparticles may also have a diameter smaller than 500 nm. However, other suitable microparticles are those accreted from primary particles to give agglomerates or aggregates whose size is from 0.2 to 100 μm.

The microparticles used in the process of the invention, in particular in the form of particles whose surface has an irregular fine structure in the nanometer range, are preferably particles comprising at least one compound selected from fumed silica, precipitated silicas, aluminum oxide, mixed oxides, doped silicates, titanium dioxides, and pulverulent polymers. Preferred particles whose surface has an irregular fine structure in the nanometer range have, by virtue of this fine structure on the surface, elevations whose aspect ratio is greater than 1, particularly preferably greater than 1.5, and very particularly preferably greater than 2.5. The aspect ratio is in turn defined as the quotient which is the ratio of the maximum height to the maximum width of the elevation.

The microparticles preferably have hydrophobic properties, and these hydrophobic properties may be attributable to the properties of the materials themselves present on the surfaces of the particles, or else may be obtained through treatment of the particles with a suitable compound.

The particles may be provided with hydrophobic properties prior to or after impression into the surface. To hydrophobicize the micro-particles prior to or after impression (anchoring) into the surface of the calendered web products, they may be treated with a compound suitable for hydrophobicization, e.g. from the group of the alkylsilanes, the fluoroalkylsilanes, and the disilazanes. Examples of compounds suitable for hydrophobicization are supplied with the name Dynasylan by Degussa AG.

A more detailed description follows of microparticles whose use is preferred. The particles used may come from a variety of fields. For example, they may be silicates, doped silicates, minerals, metal oxides, aluminum oxides, silicas, or titanium dioxides, Aerosils®, or pulverulent polymers, e.g. spray-dried and agglomerated emulsions or cryogenically milled PTFE. Particularly suitable particle systems are hydrophobicized fumed silicas, known as Aerosils®. To generate the self-cleaning surfaces, hydrophobic properties are needed alongside the structure. The particles used may themselves be hydrophobic, for example pulverulent polytetra-fluoroethylene (PTFE). The particles may have been provided with hydrophobic properties, for example Aerosil VPR 411® or Aerosil R 8200®. However, they may also be hydrophobicized subsequently. It is unimportant here whether the particles are hydrophobicized prior to application or after application. Examples of these particles to be hydrophobicized are Aeroperl 90/30®, Sipernat silica 350®, aluminum oxide C®, zirconium silicate, and vanadium-doped or VP Aeroperl P 25/20®. In the case of the latter, the hydrophobicization advantageously takes place by treatment with perfluoroalkylsilane compounds followed by heat-conditioning.

Examples of products of the process of the invention are films or protective sheeting which have self-cleaning properties and have surface structures with elevations, and have or do not have a fabric insert, nonwoven insert, or felt insert. These films may be applied to buildings, vehicles, or other articles, for example, so that these, too, have self-cleaning properties. However, the films may also be used as they stand, for example in the textile buildings sector, in particular being used as awnings or sunshade roofs, or else for protective tarpaulins, truck tarpaulins, tenting, or other protective coverings. The abovementioned protective sheeting is therefore also provided by the present invention.

The process of the invention is described using FIG. 1, but there is no intention that the invention be restricted thereto. FIG. 1 is a diagram of the surface of a web product X of the invention which comprises particles P (only one particle being depicted to simplify the presentation). The elevation formed by the particle itself has an aspect ratio of about 0.71, calculated as the quotient which is the ratio between the maximum height of the particle mH, which is 5, since only that portion of the particle which protrudes from the surface of the calendered web product X contributes to the elevation, and the maximum width mB, which in turn is 7. A selected elevation of the elevations E present on the particles by virtue of their fine structure has an aspect ratio of 2.5, calculated as the quotient which is the ratio of the maximum height of the elevation mH′, which is 2.5, to the maximum width mB′, which in turn is 1.

The process of the invention is described using the example below, but there is no intention that the invention be restricted to this example.

### EXAMPLE 1

After leaving the final calender roll (Berstorff 4-roll L calender with roll diameter 150 mm and roll surface length 350 mm) and before running around the first downstream roll, a PVC web product (SolVin 250 SB with K value 50, Solvay) of thickness 10 mil (1 mil corresponding to 25 μm) is dusted on the side facing toward the downstream roll with hydrophobic fumed silica, Aerosil R 8200, Degussa AG. The dusted web product is smoothed by means of a pair of rolls situated immediately downstream of the dusting apparatus and set to a gap width of 10 mil. The web product obtained after treatment with the pair of rolls has particles impressed into the surface of the extrudate on one side of the film, and more than 70% of these particles have been anchored with 70 to 90% of their diameter within the surface. The roll-off angle for a water droplet is determined on the resultant surface of the web product by applying a droplet to the surface and constantly increasing the inclination of the film to determine the angle at which the droplet rolls off from the surface. For a water droplet of size 40 μl the resultant roll-off angle is smaller than 21°.

As can be seen from the example, the process of the invention can give web products which have self-cleaning or water-repellent surfaces, and it makes no great difference here whether the microparticles are applied to the roll or to the extrudate.

1. A calendered web product with at least one surface which has self-cleaning properties,
wherein
the surface has at least one securely anchored layer of microparticles which have hydrophobic properties and form elevations which have an average height of from 20 nm to 25 μm and an average separation of from 20 nm to 25 μm.

2. The calendered web product as claimed in claim 1,
wherein
the elevations have an average height of from 50 nm to 4 μm and/or an average separation of from 50 nm to 4 μm.

3. The calendered web product as claimed in claim 1
wherein
the microparticles have been selected from the group consisting of particles of silicates, minerals, metal oxides, metal powders, silicas, pigments, polymers and mixtures thereof.

4. The calendered web product as claimed in claim 1,
wherein
the microparticles have an average particle size (diameter) of from 0.02 to 100 μm.

5. The calendered web product as claimed in claim 1,
wherein
the calendered web product itself comprises a material suitable for calendering.

6. The calendered web product as claimed in claim 1,
wherein
the calendered web product comprises a felt, nonwoven, or fabric coated with a material suitable for calendering.

7. A process for producing calendered web products as claimed in claim 1 with at least one surface which has self-cleaning properties and has elevations formed by microparticles,
wherein
at least one roller is used to impress microparticles which have an average particle diameter of from 0.02 to 100 μm and have hydrophobic properties into the surface of a calendered web product, where this surface has not yet solidified.

8. The process as claimed in claim 7,
wherein
the particles are impressed into the surface of the calendered web product only to the extent of not more than 90% of their diameter.

9. The process as claimed in claim 7,
wherein
the calendered web products comprise a material suitable for calendering or a felt, nonwoven, or fabric coated on one or both sides with one or more of these materials.

10. The process as claimed in claim 9,
wherein
the material suitable for calendering is a compound selected from the group consisting of polyvinyl chloride (PVC), polyisobutylene, acrylonitrile-butadiene-styrene terpolymer (ABS), natural rubber, synthetic rubber and mixtures thereof.

11. The process as claimed in claim 7,
wherein
the roller is a roller needed for producing conventional calendered web products, in particular the final calender roll or the first roll downstream of the final calender roll.

12. The process as claimed in claim 7,
wherein
the microparticles are applied to the roll prior to impressing into the calendered web products.

13. The process as claimed in claim 12,
wherein
the microparticles are sprayed onto the roll.

14. The process as claimed in claim 7,
wherein
use is made of at least two rolls, and hydrophobic microparticles are impressed on two sides of the calender into the surface of the web products.

15. The process as claimed in claim 7,
wherein
use is made of microparticles selected from the group consisting of silicates, minerals, metal oxides, metal powders, silicas, pigments, a polymers and mixtures thereof.

16. The process as claimed in claim 7,
wherein
the microparticles have hydrophobic properties by virtue of treatment with a suitable compound.

17. The process as claimed in claim 16,
wherein
the microparticles are provided with hydrophobic properties prior to or after bonding to the surface of the calendered web products.

18. A film with a surface which has self-cleaning properties and has surface structures with elevations, the production process being as claimed in claim 7.

19. A coated fabric with a surface which has self-cleaning properties and has surface structures with elevations, the production process being as claimed in claim 7.

20. The coated fabric as claimed in claim 19, suitable for use as awnings, sunshade roofs, protective tarpaulin covers, truck tarpaulins, tenting, or other protective coverings.
